(19) United States
(12) Patent Application Publication
(10) Pub. No.: US 2021/0149174 A1
(43) Pub. Date: May 20, 2021

(54) HISTOLOGY-GRADE THREE-DIMENSIONAL IMAGING OF TISSUE USING MICROSCOPY WITH ULTRAVIOLET SURFACE EXCITATION

(71) Applicant: The Regents of the University of California, Oakland, CA (US)

(72) Inventors: Richard M. Levenson, Davis, CA (US); Farzad Fereidouni, Davis, CA (US)

(73) Assignee: The Regents of the University of California, Oakland, CA (US)

(21) Appl. No.: 17/046,722

(22) PCT Filed: Apr. 22, 2019
(86) PCT No.: PCT/US19/28564

§ 371 Date: Oct. 9, 2020

Related U.S. Application Data
(60) Provisional application No. 62/662,578, filed on Apr. 25, 2018.

(51) Int. Cl. G02B 21/36; G01N 1/06; G01N 1/42; G01N 1/30; G01N 1/31; G01N 21/64; G02B 21/16; G02B 21/26; G02B 21/06

(52) U.S. Cl. CPC G02B 21/365; G01N 1/06; G01N 1/42; G01N 1/30; G01N 1/31; G01N 21/6428; G01N 2021/6439; G02B 21/16; G02B 21/26; G02B 21/06; G01N 2001/302; G01N 2001/317; G01N 21/6458

(57) ABSTRACT

The disclosed embodiments relate to a system that performs a three-dimensional (3D) imaging operation on a sample of biological material. During operation, the system obtains the sample of biological material, and performs a sequence of sectioning operations on the sample to successively remove sections of the sample. While the sequence of sectioning operations is taking place, the system performs an imaging operation on an exposed block face of the sample after each sectioning operation using microscopy with ultraviolet surface excitation (MUSE) surface-weighted imaging Finally, the system assembles images produced by the block-face imaging operations into a three-dimensional dataset for viewing and analysis.

### RELATED APPLICATION

This application claims priority under 35 U.S.C. § 119 to U.S. Provisional Application No. 62/662,578, entitled “Histology-Grade Three-Dimensional Imaging of Tissue Using Microscopy with Ultra-Violet Surface Excitation” by the same inventors as the instant application, filed on 25 Apr. 2018, the contents of which are incorporated by reference herein.

### GOVERNMENT LICENSE RIGHTS

This invention was made with U.S. government support under grant number R33 CA202881 awarded by the National Institutes of Health (NIH). The U.S. government has certain rights in the invention.

### BACKGROUND

### Field

The disclosed embodiments relate to techniques for generating three-dimensional (3D) images of biological tissue. More specifically, the disclosed embodiments relate to a technique for generating histology-grade 3D images of tissue samples using a microscopy with ultraviolet surface excitation (MUSE) imaging system.

### Related Art

Developments in 3D medical imaging technologies, such as magnetic resonance imaging (MRI), have revolutionized the practice of medicine by enabling health care professionals to better visualize and diagnose a wide range of medical ailments. However, existing 3D imaging techniques have drawbacks in terms of cost, accessibility, ease of use, resolution, tissues that can be imaged, and contrast mechanisms. Existing medical imaging technologies (e.g., PET, MRI, and CT) typically provide limited resolution (about 0.1 mm to 3 mm) and limited contrast mechanisms, even when specialized stains are used. Moreover, system costs range from $500,000 to millions and accessibility is limited to larger institutions having appropriate personnel and core facilities. Bioluminescence and in-vivo fluorescence imaging systems provide even less resolution and very limited contrast mechanisms. Conventional serial histology techniques for generating 3D images are extremely labor-intensive and are prone to inaccurate 3D registration. Conventional cryo-imaging techniques can be performed on large samples (as large as a rat). However, resolution is limited by light scatter. Knife-edge microscopy systems operate by imaging a tissue section using a diamond knife that also illuminates; however, these systems require precise alignment of a camera in a rolling shutter configuration with knife movement and speed, and the systems are quite expensive. Other approaches use multi-photon imaging configurations, which are complicated and expensive.

A number of optical imaging modalities (e.g., light-sheet microscopy) are being combined with tissue clearing to image small to mouse-sized samples. By adding compounds that either homogenize the refractive index throughout the tissue or remove highly scattering components (e.g., lipids), scattering can be reduced and tissues can be made transparent. This approach is popular for producing high-resolution, 3D images of intact organs (e.g., brain tissue). Although this technique has advantages, it also has limitations. Most protocols are time-intensive and involve many steps, some diminish or quench fluorescence, some distort tissues, all can remove components of interest, and none are ideal with large samples (e.g., a whole mouse). Moreover, cleared tissue is imaged with expensive microscopes (e.g., light-sheet or 2-photon) with associated tradeoffs between resolution and field of view.

Hence, what is needed is a new technique for generating high-resolution 3D images of tissue samples without the above-described drawbacks of existing techniques.

### SUMMARY

The disclosed embodiments relate to a system that performs a three-dimensional (3D) imaging operation on a sample of biological material. During operation, the system obtains the sample of biological material, and performs a sequence of sectioning operations on the sample to successively remove sections of the sample. While the sequence of sectioning operations is taking place, the system performs an imaging operation on an exposed block face of the sample after each sectioning operation using microscopy with ultraviolet surface excitation (MUSE) surface-weighted imaging. Finally, the system assembles images produced by the block-face imaging operations into a three-dimensional dataset for viewing and analysis.

In some embodiments, the sequence of sectioning operations is performed using: a microtome; a cryotome; a vibratome; a compresstome; a diamond wire; or a laser.

In some embodiments, the system selectively retains one or more removed tissue sections for downstream analyses.

In some embodiments, a removed tissue section is selectively retained based on characteristics of an image of a block face associated with the tissue section.

In some embodiments, the system stains the sample of biological material prior to performing the imaging operations.

In some embodiments, staining the sample involves staining the entire sample prior to performing the sequence of sectioning operations.

In some embodiments, staining the sample involves performing a section-by-section staining operation, which stains a new block face that is exposed after each sectioning operation prior to imaging the new block face.

In some embodiments, each section-by-section staining operation involves using one of the following application techniques: spraying via aerosols or droplets; liquid delivery; vapor delivery; and transfer of stains using a stain-containing pad or other support.

In some embodiments, after each staining operation, the system performs a wash step, if necessary.

In some embodiments, while staining the sample, the system aids tissue penetration with ultrasound, microwaves or other mechanical aids.

In some embodiments, staining the sample involves perfusion of the sample either in vivo or ex vivo using stains, fixatives, and/or other tissue-modifying agents.

In some embodiments, staining the sample involves using one or more of the following stains: a fluorescent stain; an immunostain; a molecularly targeted stain using antibodies; a peptide; a targeted stain having a chemical affinity, which is different from an immunofluorescent tissue dye; a solvent; and a pH-modifier.

In some embodiments, the system applies a contrast enhancer, such as acetic acid, to the sample to improve tissue image contrast.

In some embodiments, the imaging operation involves using a second imaging modality in addition to MUSE, wherein the second imaging modality can include fluorescence microscopy or fluorescence lifetime imaging (FLIM).

In some embodiments, the system facilitates expansion microscopy by applying a supporting matrix, such as acrylamide, to the sample, wherein the supporting matrix swells and increases dimensions of cells in the sample prior to the imaging operations.

In some embodiments, the sample is one of: a fresh sample; a fixed sample; a frozen sample; and a sample embedded in a supporting matrix.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 illustrates a 3D imaging system in accordance with the disclosed embodiments.

FIG. 2 presents a flow chart of a process for performing 3D imaging based on MUSE in accordance with the disclosed embodiments.

FIG. 3A illustrates eosin-stained kidney tissue excited at 405 nm in accordance with the disclosed embodiments.

FIG. 3B illustrates eosin-stained kidney tissue excited at 280 nm in accordance with the disclosed embodiments.

FIG. 4A illustrates a MUSE image of a thin histological section of prostate tissue in accordance with the disclosed embodiments.

FIG. 4B illustrates a virtual hematoxylin and eosin (H&E) image computed from the MUSE image in accordance with the disclosed embodiments.

FIG. 4C illustrates an actual H&E image in accordance with the disclosed embodiments.

FIG. 5A illustrates a color cryo-image of a mouse embryo in accordance with the disclosed embodiments.

FIG. 5B illustrates a fluorescence cryo-image of a mouse embryo in accordance with the disclosed embodiments.

FIG. 5C illustrates an RGB-MUSE cryo-image of a mouse embryo in accordance with the disclosed embodiments.

FIG. 6A illustrates a 3D image of a brain, which includes a trigeminal ganglion and a hindbrain, in accordance with the disclosed embodiments.

FIG. 6B illustrates an image slice through the trigeminal ganglion in accordance with the disclosed embodiments.

FIG. 6C illustrates an image slice through the hindbrain in accordance with the disclosed embodiments.

FIG. 7 illustrates a 3D-MUSE cryo-image of a mouse embryo in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules. The methods and processes described in the detailed description section can be embodied as code and/or data, which can be stored in a computer-readable storage medium as described above.

### Overview

The disclosed embodiments facilitate 3D imaging of biological tissue specimens. Thick specimens can be sequentially sectioned using vibratome, compresstome, cryotome or microtome technologies, wherein block-face imaging takes place after every sectioning operation using MUSE surface-weighted imaging. An advantage of this technique is that staining of each new block face can be accomplished in just a few seconds, which means that large tissue blocks do not need to be labeled in depth up-front, before sectioning proceeds. Alternatively, the specimen can be labeled in advance, either ex vivo, using longer incubation times, or labeling can occur in vivo before sacrifice. Moreover, the tissue can be viable and some functional aspects can be monitored during the 3D-sectioning procedure. Because each block-face image is reasonably well registered with respect to a previous image, depending on how much slice-to-slice tissue movement occurs, it is possible to create 3D reconstructions, which are essentially unlimited in the axial direction, and with an x-y extent determined by the sectioning methodology used. Thus, images can be assembled in software to form a 3D image allowing for navigation and exploration.

The disclosed embodiments take advantage of a new imaging modality called “Microscopy with UV Surface Excitation (MUSE),” which provides a straightforward and inexpensive imaging technique that produces diagnostic-quality images, with enhanced spatial and color information, directly and quickly from fresh or fixed tissue. The imaging process is non-destructive, permitting downstream molecular analyses. (See Farzad Fereidouni, et al., “Microscopy with UV Surface Excitation (MUSE) for slide-free histology and pathology imaging,” Proc. SPIE 9318, Optical Biopsy XIII: Toward Real-Time Spectroscopic Imaging and Diagnosis, 93180F, 11 Mar. 2015.)

To facilitate MUSE imaging, samples are briefly stained with common fluorescent dyes, followed by 280 nm UV light excitation that generates highly surface-weighted images due to the limited penetration depth of light at this wavelength. This technique also takes advantage of the “USELESS” (UV stain excitation with long emission Stokes shift) phenomenon for broad-spectrum image generation in the visible range. Note that MUSE readily provides surface topography information even in single snapshots, and while not fully three-dimensional, the images are easy to acquire, and easy to interpret, providing more insight into tissue structure.

The disclosed embodiments make it possible to perform 3D imaging based on MUSE, which is referred to as 3D-MUSE. 3D-MUSE provides a powerful new technique for performing automated, extended-depth 3D histology-quality imaging of small-to-large (e.g., whole mouse) specimens, thereby enabling a large number of biological and preclinical applications. In addition to autofluorescence, the system can utilize fluorescent contrasts from superficially applied and perfused histology stains, fluorescent proteins (e.g., transgenic animals, gene therapy, and labeled exogenous cells), in-vivo imaging agents, and imaging or theranostic nanoparticles. Potential applications include tissue 3D microanatomy, mouse model phenotyping, embryo cell lineage tracking, monitoring of nanoparticle delivery, detection of metastatic cancer, and investigation of cancer pathophysiology, immunotherapy, stem cells, toxicology, mapping of disease processes in preclinical and human organs, and an array of animal and plant basic biology studies.

3D-MUSE also addresses issues of cost and throughput. In some laboratories, large fractions of research budgets are allocated to acquisition and analysis of histology. Researchers are often stymied because they desire experiments with extensive histological analysis, but cost and labor are prohibitive. Automated 3D-MUSE can greatly reduce this burden by facilitating image-guided histology, and providing morphologically guided molecular analyses, which will enable faster, less technically demanding, and more accurate experiments.

Currently, isolated 2D histology slices make it nearly impossible to fully appreciate 3D microanatomy. By providing histology-quality images, 3D-MUSE makes it possible to easily acquire 3D microanatomy. Normal and diseased structures of interest include: nephron units (glomeruli, and associated vessels and tubules); breast lobular architecture and connected duct systems; brain (vessels, ventricles, defined functional regions, choroid plexus); and liver (mixed vasculature—hepatic and systemic vessels, bile ducts).

In a 3D-MUSE system, imaging times will not be as limiting as might be imagined. By exciting at one wavelength and imaging with a color camera, it is possible to obtain all fluorescence data in a single snapshot. Consider 3D-MUSE-cryo with 4-μm imaging over a 1.8-cm×1.2-cm field of view (FOV), which will accommodate most embryos on their side. At 3.5 seconds per slice, it is possible to obtain histology-quality at 4-μm×4-μm×20-μm resolution in 23 minutes or at 4-μm×4-μm×40-μm resolution in 11.5 minutes. With tiling of a large stage, it is possible to image 40 embryos overnight. By contrast, in previous studies, it took five hours to image a single postnatal mouse using μCT and 6-24 hours to image multiple embryos using MRI. Note that although MRI and CT provide anatomical images, they do not image gene reporters and use limited stains.

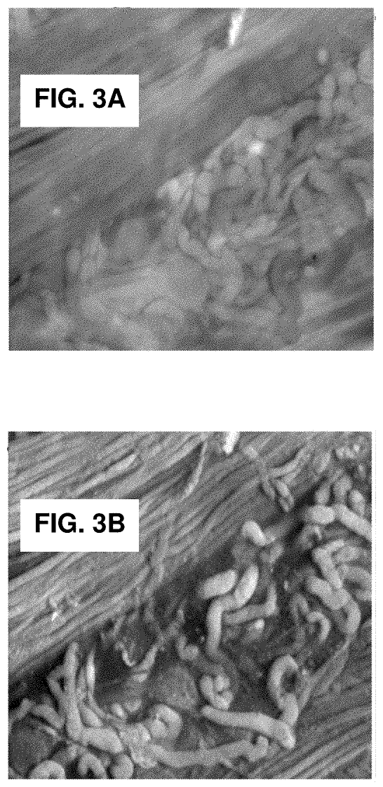

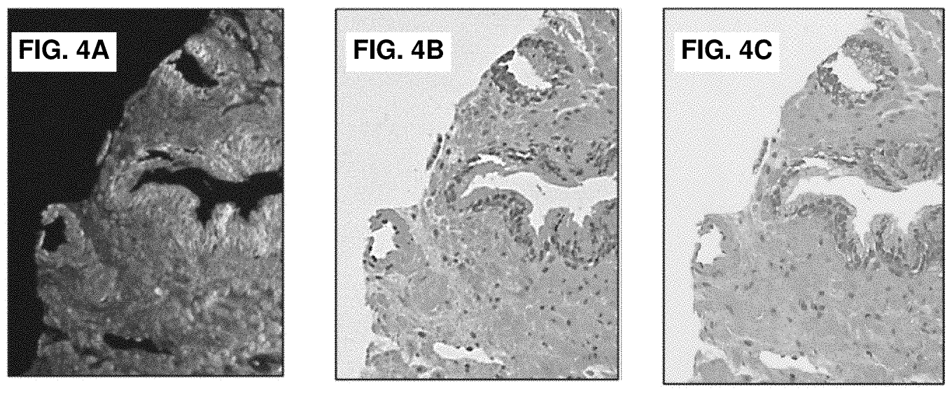

Preliminary results are promising. FIGS. 3A-3B and 4A-4C illustrate conventional MUSE results obtained with fresh or fixed tissue cut with a knife, placed on a stage with a UV-transparent sapphire window, and imaged with an inverted MUSE microscope. FIGS. 3A-3B illustrate how excitation at 280 nm improves image quality due to reduced light penetration of the surface. More specifically, FIG. 3A illustrates how eosin-stained kidney tissue produces a blurred image when excited at 405 nm. In contrast, FIG. 3B illustrates the exquisite detail that can be achieved using MUSE when the tissue is excited at 280 nm due to MUSE's<10 nm light penetration.

FIGS. 4A-4C illustrate excellent correspondence between MUSE and standard H&E. More specifically, FIG. 4A illustrates an image of a thin histological section of prostate tissue, which provides a gamut of colors when stained with eosin, Hoechst and propidium iodide. FIG. 4B illustrates a virtual H&E image computed from a MUSE image, which shows enhanced stromal detail not evident in the same slide subsequently stained with H&E, which is illustrated in FIG. 4C. Note that virtual H&E from MUSE provides improved cellular definition as compared to conventional H&E.

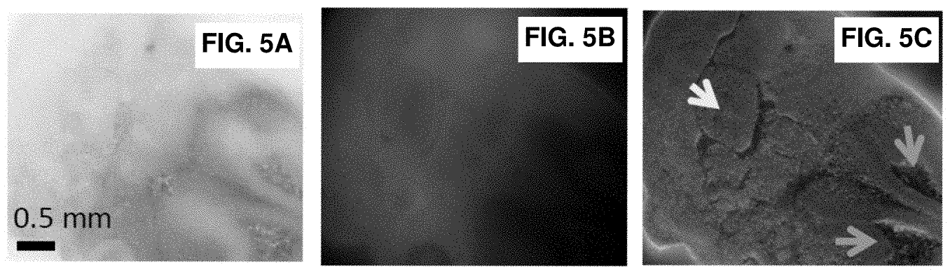

FIGS. 5A-5C show that MUSE images of the block face have much better effective resolution than those from conventional fluorescence imaging, which suffer from light scatter at this scale. More specifically, FIGS. 5A-5C provide a comparison of cryo-imaging and 3D-MUSE-cryo imaging of a E12.5 mouse embryo (Rosa 26TdTomato under the Engrailed1cre promoter). Because of reduced light penetration, the RGB-MUSE image illustrated in FIG. 5C shows much more detail than the color image illustrated in FIG. 5A and the fluorescence illustrated in FIG. 5B. Note that tongue and brain ventricles are clearly visible in the MUSE images in FIG. 5C (yellow and blue arrows, respectively) but are not visible in the conventional images illustrated in FIGS. 5A and 5B.

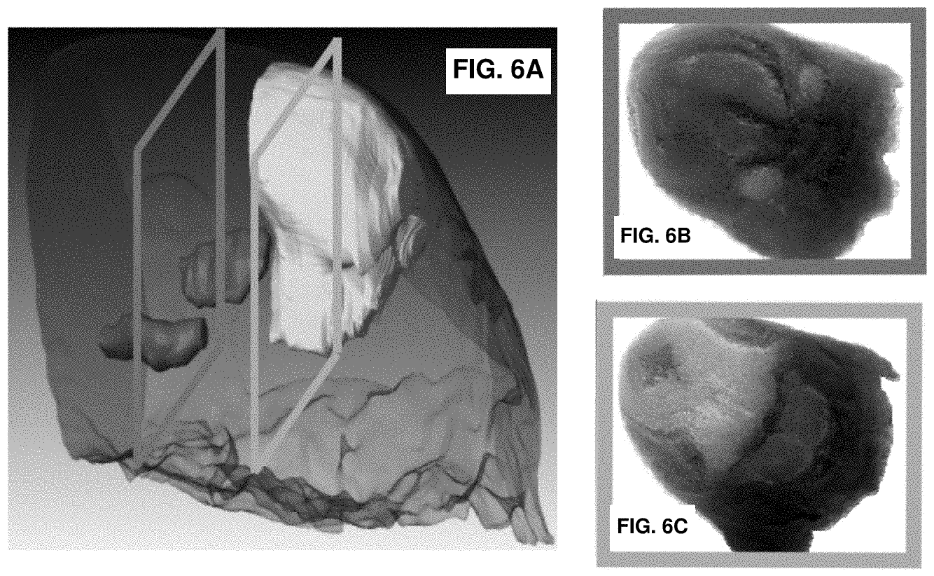

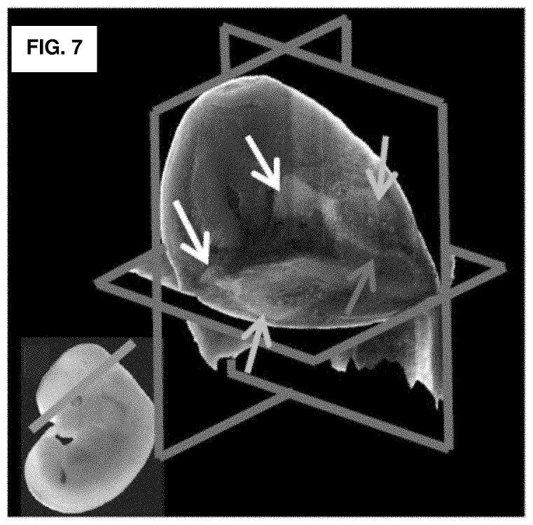

FIGS. 6A-6C and FIG. 7 illustrate 3D-MUSE-cryo images of a mouse embryo (E12.5 Rosa 26TdTomato under the Engrailed1cre promoter). In FIGS. 6A-6C, regions of high TdTomato expression are segmented: trigeminal ganglion (magenta) and hindbrain (yellow). The original image slices corresponding to the planes in FIG. 6A are illustrated in FIGS. 6B and 6C, respectively. Note that the skin was digitally removed because high expression limited dynamic range. FIG. 7 provides 3D-MUSE-cryo image of a mouse embryo, which shows bright red fluorescence in a transgenic embryo (E12.5 Rosa 26TdTomato under the Engrailed1cre promoter) used to study development. Note that only the top of the mouse embryo is shown in FIG. 7, with a horizontal cut plane illustrated in the inset in the bottom left corner of FIG. 7. Also, labeled cells are in locations identified by the arrows: trigeminal ganglion (white), hindbrain (gold), and eminence of trigeminal ganglion (blue). Hence, the resulting image quality illustrated in FIGS. 6A-6C and 7 is similar to what can be obtained from 2D cryo-section histology.

### 3D Imaging System

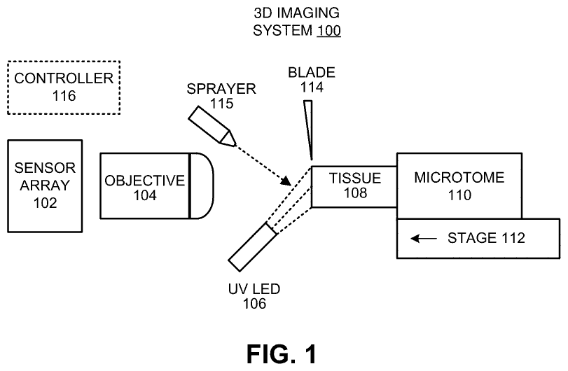

FIG. 1 illustrates an exemplary 3D imaging system 100 that captures an image of a tissue sample 108 in accordance with the disclosed embodiments. More specifically, FIG. 1 illustrates an imaging device, which is comprised of a sensor array 102 and an objective 104. This imaging device acquires an image of a tissue sample 108, which is affixed to a sectioning device, such as a microtome 110, which includes a blade 114 for performing a sequence of sectioning operations. Microtome 110 is located on a movable stage 112. (Note that the sectioning device can generally include any type of device that can cut sections from tissue sample 108, including: a microtome; a cryotome; a vibratome; a compresstome; a diamond wire; or a laser.)

During operation of 3D imaging system 100, the imaging device, comprised of objective 104 and sensor array 102, acquires a sequence of images of tissue sample 108 between successive sectioning operations. During these sequential imaging operations, a UV LED 106 illuminates the sample 108 with UV light, which has a wavelength of □280 nm to facilitate MUSE imaging. Also, an optional staining device comprising a sprayer 115 can be used to perform a section-by-section staining operation, which stains a new block face that is exposed after each sectioning operation prior to imaging the new block face. All of the components illustrated in FIG. 1 are operated by a controller 116.

3D imaging system 100 can be implemented using an Olympus objective, which has a high NA (0.5), long working distance (20 mm), and a large front aperture. To utilize the full back aperture of the objective and achieve a large field of view, a lower magnification can be used (0.63×, NA=0.15). Note that the Olympus objective has a tube lens. In theory, this combination can produce ˜3.2× magnification with <1 μm resolution. By combining the Olympus lenses with a high-quality, CMOS color camera (Nikon D850 DSLR 45.7 megapixels), it is possible to achieve an 11.2×7.5 mm field of view with pixel-limited resolution (˜2.7 μm). It is also possible to use different objectives, either with separate systems or with a turret to increase the field of view or resolution. For example, the Canon EF-S 60 mm lens makes it possible to design a system yielding <10 μm resolution over a 36-mm×24-mm field of view. Because 280 nm light does not transmit well through commercial microscope objectives, the sample can be illuminated obliquely with a bright LED array. Simple relay optics can be implemented to obtain uniform illumination. Because 3D-MUSE can stimulate multiple fluorophores emitting at different wavelengths simultaneously, using a color camera can simplify the optical design and reduce cost (because no emission filters are needed) and can greatly speed imaging time.

The system can be configured to accommodate fixed or fresh tissues by modifying an existing vibrating blade sectioning system (Compresstome), hereinafter called “3D-MUSE-vibro.” It can also be configured to provide a system for frozen tissues by modifying an existing CryoViz™, hereafter called “3D-MUSE-cryo.” It can be further configured to provide a system for tissues stabilized in an embedding matrix material (e.g., paraffin or resins), hereafter called “3D-MUSE-matrix.” The various configurations offer tradeoffs among tissue preparation, associated costs, quality and thickness of tissue sectioning, field of view, image resolution, image contrast, and ability to create high-quality 3D volumes.

A 3D-MUSE-cryo system can be implemented, which is suitable for imaging an entire frozen mouse with in-slice resolution as good as 2.7 μm. This can be accomplished by modifying a CryoViz housed in a BioInVision system, which is capable of whole mouse section-and-imaging using a microscope mounted on a robotic system capable of tiling images of the block face of tissue. Features include fully automated section-and-imaging with status text messaging, MUSE imaging, color imaging, multispectral fluorescence imaging, digitally controlled slice thickness (2 μm-2000 μm), large sample sizes (up to a whole rat), automated image tiling, and remote image display. To speed imaging, variable thickness imaging can be implemented, where most section-and-imaging will occur at 200 μm, with interspersed groups of 5 μm thickness to determine microanatomy. Using an adhesive film, it is possible to pick up sections to obtain histological images exactly matching the block-face image. This makes it possible to perform “image-guided histology,” wherein 2D/3D images are monitored to determine a region of interest. Then, sectioning is paused, and a section is collected for additional processing (e.g., antibodies and laser capture dissection). This makes it possible to include all types of molecular data within a 3D-MUSE volume, which is an exciting possibility for studies of disease, therapy, and development.

A 3D-MUSE-matrix system can be configured to facilitate 3D-MUSE imaging of samples embedded in any suitable rigid matrix. This can be implemented using a bench top, room temperature digital microtome system created by BiolnVision Inc., which is outfitted with microscope and lighting as described above. For simplicity, this system can allow color with white light illumination and MUSE. Nearly all system functions identified for 3D-MUSE-cryo can be included on this system, because it will have a standard BiolnVision interface. This system will provide good resolution with 1-μm paraffin sectioning and with absorbers added to the paraffin to further reduce UV penetration. It is also possible to add control to facilitate tiled acquisitions.

A 3D-MUSE-vibro system can be implemented using a vibrating microtome (Compresstome VF-300), which is modified for 3D-MUSE imaging. The compresstome can section fresh or fixed tissues stabilized by low-melting-point agarose. Advantages of this system include: tissue block face staining; quick tissue preparation; and variable section widths (3-2000 μm). In preliminary manual experiments, staining and imaging operations were demonstrated with repeated 10-μm sectioning of the block face with good registration of images and no obvious tissue-cutting artifacts. It is also possible to include an automated mist spray system for staining the tissue block face. In this system, the section-and-image operations can be controlled via a LabView interface. Images can also be saved in the BiolnVision format (TIFF with a metafile), which makes it possible to use existing visualization and analysis software.

### Capturing and Processing an Image

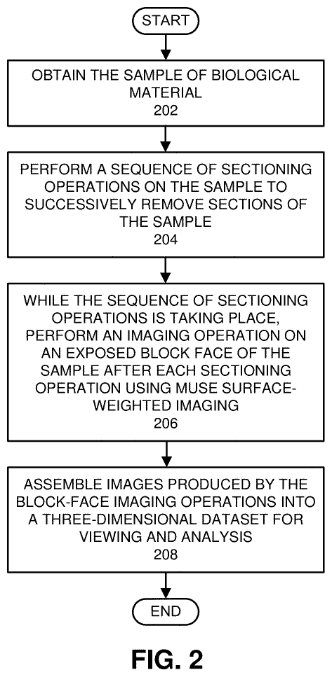

FIG. 2 presents a flow chart of a process for performing 3D imaging based on MUSE in accordance with the disclosed embodiments. During operation, the system obtains the sample of biological material (step 202), and performs a sequence of sectioning operations on the sample to successively remove sections of the sample (step 204). While the sequence of sectioning operations is taking place, the system performs an imaging operation on an exposed block face of the sample after each sectioning operation using microscopy with ultraviolet surface excitation (MUSE) surface-weighted imaging (step 206). Finally, the system assembles images produced by the block-face imaging operations into a three-dimensional dataset for viewing and analysis (step 208).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

1. A method for performing a three-dimensional (3D) imaging operation on a sample of biological material, comprising:
obtaining the sample of biological material;
performing a sequence of sectioning operations on the sample to successively remove sections of the sample;
while the sequence of sectioning operations is taking place, performing an imaging operation on an exposed block face of the sample after each sectioning operation using microscopy with ultraviolet surface excitation (MUSE) surface-weighted imaging; and
assembling images produced by the block-face imaging operations into a three-dimensional dataset for viewing and analysis.

2. The method of claim 1, wherein the sequence of sectioning operations is performed using one of:
a microtome;
a cryotome;
a vibratome;
a compresstome;
a diamond wire; and
a laser.

3. The method of claim 1, wherein the method further comprises selectively retaining one or more removed tissue sections for downstream analyses.

4. The method of claim 3, wherein a removed tissue section is selectively retained based on characteristics of an image of a block face associated with the tissue section.

5. The method of claim 1, wherein the method further comprises staining the sample of biological material prior to performing the imaging operations.

6. The method of claim 5, wherein staining the sample involves staining the entire sample prior to performing the sequence of sectioning operations.

7. The method of claim 5, wherein staining the sample involves performing a section-by-section staining operation, which stains a new block face that is exposed after each sectioning operation prior to imaging the new block face.

8. The method of claim 7, wherein each section-by-section staining operation involves using one of the following application techniques:
spraying via aerosols or droplets;
liquid delivery;
vapor delivery; and
transfer of stains using a stain-containing pad or other support.

9. The method of claim 7, wherein after each staining operation, the method further comprises performing a wash step, if necessary.

10. The method of claim 5, wherein while staining the sample tissue penetration is aided with ultrasound, microwaves or other mechanical aids.

11. The method of claim 5, wherein staining the sample involves perfusion of the sample either in vivo or ex vivo using stains, fixatives, and/or other tissue-modifying agents.

12. The method of claim 5, wherein staining the sample involves using one or more of the following stains:
a fluorescent stain;
an immunostain;
a molecularly targeted stain using antibodies;
a peptide;
a targeted stain having a chemical affinity, which is different from an immunofluorescent tissue dye;
a solvent; and
a pH-modifier.

13. The method of claim 1, wherein the method further comprises applying a contrast enhancer, such as acetic acid, to the sample to improve tissue image contrast.

14. The method of claim 1, wherein performing the imaging operation involves using a second imaging modality in addition to MUSE, wherein the second imaging modality can include fluorescence microscopy or fluorescence lifetime imaging (FLIM).

15. The method of claim 1, wherein the method further comprises facilitating expansion microscopy by applying a supporting matrix, such as acrylamide, to the sample, wherein the supporting matrix swells and increases dimensions of cells in the sample prior to the imaging operations.

16. The method of claim 1, wherein the sample is one of:
a fresh sample;
a fixed sample;
a frozen sample; and
a sample embedded in a supporting matrix.

17. A system for performing 3D imaging of a sample of biological material, comprising:
a stage for holding the sample;
a sectioning device, which performs a sequence of sectioning operations on the sample to successively remove sections of the sample;
a light source for illuminating the sample, wherein the light source produces ultraviolet light with a wavelength in the 230 nm to 300 nm range to facilitate microscopy with ultraviolet surface excitation (MUSE) imaging;
an imaging device, comprising,
an objective that magnifies the illuminated sample, and
a sensor array that captures an image of the magnified sample;
a controller that controls the sectioning device and the imaging device to perform an imaging operation on an exposed block face of the sample after each sectioning operation using MUSE surface-weighted imaging; and
an image-processing system that assembles a set of images generated by the imaging operations into a three-dimensional dataset for viewing and analysis.

18. The system of claim 17, wherein the sectioning device comprises one of:
a microtome;
a cryotome;
a vibratome;
a compresstome;
a diamond wire; and
a laser.

19. The system of claim 17, wherein the system additionally includes a retaining mechanism that selectively retains one or more removed tissue sections for downstream analyses.

20. The system of claim 19, wherein a removed tissue section is selectively retained based on characteristics of an image of a block face associated with the tissue section.

21. The system of claim 17, wherein the system further comprises a staining mechanism that stains the sample of biological material prior to performing the imaging operations.

22. The system of claim 21, wherein the staining mechanism stains the entire sample prior to performing the sequence of sectioning operations.

23. The system of claim 21, wherein the staining mechanism performs a section-by-section staining operation, which stains a new block face that is exposed after each sectioning operation prior to imaging the new block face.

24. The system of claim 23, wherein each section-by-section staining operation involves using one of the following application techniques:
spraying via aerosols or droplets;
liquid delivery;
vapor delivery; and
transfer of stains using a stain-containing pad or other support.

25. The system of claim 23, wherein after each staining operation, the staining mechanism performs a wash step, if necessary.

26. The system of claim 21, wherein the staining mechanism aids tissue penetration with ultrasound, microwaves or other mechanical aids.

27. The system of claim 21, wherein the staining mechanism facilitates perfusion of the sample either in vivo or ex vivo using stains, fixatives, and/or other tissue-modifying agents.

28. The system of claim 21, wherein the staining mechanism uses one or more of the following stains:
a fluorescent stain;
an immunostain;
a molecularly targeted stain using antibodies;
a peptide;
a targeted stain having a chemical affinity, which is different from an immunofluorescent tissue dye;
a solvent; and
a pH-modifier.

29. The system of claim 17, wherein the system additionally applies a contrast enhancer, such as acetic acid, to the sample to improve tissue image contrast.

30. The system of claim 17, wherein the imaging device uses a second imaging modality in addition to MUSE, wherein the second imaging modality can include fluorescence microscopy or fluorescence lifetime imaging (FLIM).

31. The system of claim 17, wherein the system facilitates expansion microscopy by applying a supporting matrix, such as acrylamide, to the sample, wherein the supporting matrix swells and increases dimensions of cells in the sample prior to the imaging operations.

32. The system of claim 17, wherein the sample is one of:
a fresh sample;
a fixed sample;
a frozen sample; and
a sample embedded in a supporting matrix.
